(19) United States
(12) Patent Application Publication
(10) Pub. No.: US 2005/0177578 A1
(43) Pub. Date: Aug. 11, 2005

(54) Efficient type annontation of XML schema-validated XML documents without schema validation

(76) Inventors: Yao-Ching Stephen Chen, San Jose, CA (US); Ning Wang, Irvine, CA (US); Guogen Zhang, San Jose, CA (US)

Correspondence Address: LACASSE & ASSOCIATES, LLC, 1725 DUKE STREET, SUITE 650, ALEXANDRIA, VA, 22314, US

(21) Appl. No.: 10/774,584

(22) Filed: Feb. 10, 2004

(51) Int. Cl. G06F 7/00

(52) U.S. Cl. 707/100

(57) ABSTRACT

Type annotation record information storage for annotated automaton encoding for high-performance XML schema validation is optimized in a space efficient aspect. Subsequent to type annotation record information organization, type annotation records are used for type annotation of validated XML documents, either by implementing annotation records and type annotation part of an algorithm only, or by skipping one or more validation steps in a full validation implementation. Given a schema context, a type annotation may be performed for a validated XML fragment as opposed to an entire document. In addition, default features such as attribute and type are supported.

### RELATED APPLICATIONS

This application is related to the application entitled “Annotated Automaton Encoding of XML schema for High Performance Schema Validation”, now U.S. Ser. No. 60/418,673, which is hereby incorporated by reference in its entirety, including any appendices and references thereto.

### BACKGROUND OF THE INVENTION

1. Field of Invention

The present invention relates generally to the field of schema validation and type annotation. More specifically, the present invention is related to efficient type annotation of validated XML documents.

2. Discussion of Prior Art

Validation of XML documents against an XML schema is an expensive process. It limits the throughput of XML database systems supporting high-volume transactions. Fortunately, there are alternatives to off-load expensive validation from a database server. For example, a document can be validated at the client's side before resuming transactions with a server or without schema validation at all if XML documents are generated from trusted and well-tested sources that can largely guarantee the validity of XML documents.

However, type information and default values for XML documents or document fragments are required by XQuery and XPath 2.0 data model when there is XML schema feature support. The overall idea of supporting type annotation without full schema validated documents or fragments is based on the named type system of XML schema. In a named type system, types are based on names instead of structures. Names determine types and structures. Although un-typed XML documents or document fragments can be supported by dynamic typing feature of XML query languages, typed XML documents can improve query performance dramatically. Furthermore, dynamic typing of XML query languages has limitations in that there is no guarantee that all type-related features will be supported since type inference is very difficult for un-typed XML documents. XQuery and XPath 2.0 have many type-related features. Existing XML schema validation techniques and schema object parsers necessitate validation for type annotation.

Therefore, there is a need for a database engine to perform fast type annotation of XML documents or document fragments for XML schema-validated XML documents in the absence of the validation process, thus avoiding unnecessary overhead. Known techniques are limited in the efficiency of their approaches to type annotation without validation. The present invention, based on the name to type mapping, saves computational cost in annotating type by omitting the pushdown automata steps of known techniques. In an annotation record data structure used in type annotation, each element type contains a list of sub-elements, which are unique within a local scope. However, a current annotation record for a current scope is also necessary along with the ability to search a local list to find an annotation record for a specified sub-element. The present invention provides an efficient method of type annotation by introducing data structures in addition to annotation record structures, and also by explicitly handling the derivation of relationships by using a type hierarchy.

Whatever the precise merits, features, and advantages of the above cited references, none of them achieves or fulfills the purposes of the present invention.

### SUMMARY OF THE INVENTION

The present invention provides for a system and method to build an XML type hierarchy, populate a type indexing data structure and typing array, map a type name string to an element type in an XML type hierarchy, and annotate types in an XML document or fragment. Based on a named type system of an XML schema, type annotation without full schema validation for documents and fragments is supported. Type annotation, based on a mapping of names to type annotation records, is achieved via the compilation of an XML schema into type annotation records.

Full validation for documents and fragments using either type annotation along with schema validation or type annotation alone can be achieved by patent application commonly assigned U.S. Ser. No. 60/418,673 by omitting the step of supplying tokens to a pushdown automata; the omitted step performs validation by using type annotation records.

Using an optimized data structure such as that described in 60/418,673 at the time of schema compilation, a runtime engine of the present invention can efficiently annotate either an entire XML document or an XML fragment. The system of the present invention comprises a type annotation record builder, which is part of an XML schema compiler (e.g., as shown in 60/418,673), a type annotation runtime engine, and a type annotation data structure. A type annotation data structure further comprises a type hierarchy tree, a typing array, and a typing index.

A type annotation record builder is used to compile an XML schema into type annotation records. The present invention uses a simple array data structure to search for a type record. Since the name of an element cannot uniquely determine an element type, a data structure is needed keep track of scopes in which a specified element type is defined; this is achieved by the use of a stack data structure. A type annotation runtime engine takes a SAX-like event or DOM-like tree and annotates each event or tree node with type information, based on previously compiled type annotation records.

In addition, one embodiment of the present invention provides for the handling of default values if they exist in supplied XML data. Defaults are specified in an XML schema and are supplied during validation. There are two kinds of default values; a default value for an attribute when an attribute is missing in an element, and default content for an element when an element is empty, (e.g., <a></a>, or <a/>). Default values are explicitly determined, and are no longer default, after validation. This provision is of interest because default values are not explicitly determined since the present invention does not require schema validation. Support for attribute defaults is achieved via association of attribute types with element types in compiled type annotation records. If schema validation occurs, attributes are also associated with element start tags, such that any missing attributes with a default value can be found from type records. This is achieved through the comparison of lists of attribute types with attribute instances for a particular element.

In another embodiment of the present invention, support for “any” type and “xsi:nil=‘true’” is also achieved. If an unknown type appears in an XML instance; specifically, if a type name is not found in a name-to-type mapping, the unknown type is annotated with “any” type. To support of an element having an “xsi:nil=‘true’” attribute, the step of annotation is omitted.

### BRIEF DESCRIPTION OF THE DRAWINGS

FIG. 1 illustrates the system of the present invention.

FIG. 2 is a process flow diagram for an XML compilation algorithm of the present invention.

FIG. 3 is an exemplary XML schema.

FIG. 4 is an XML type hierarchy tree.

FIG. 5 illustrates type annotation records data structure.

FIG. 6 is a process flow diagram for XML type record annotation.

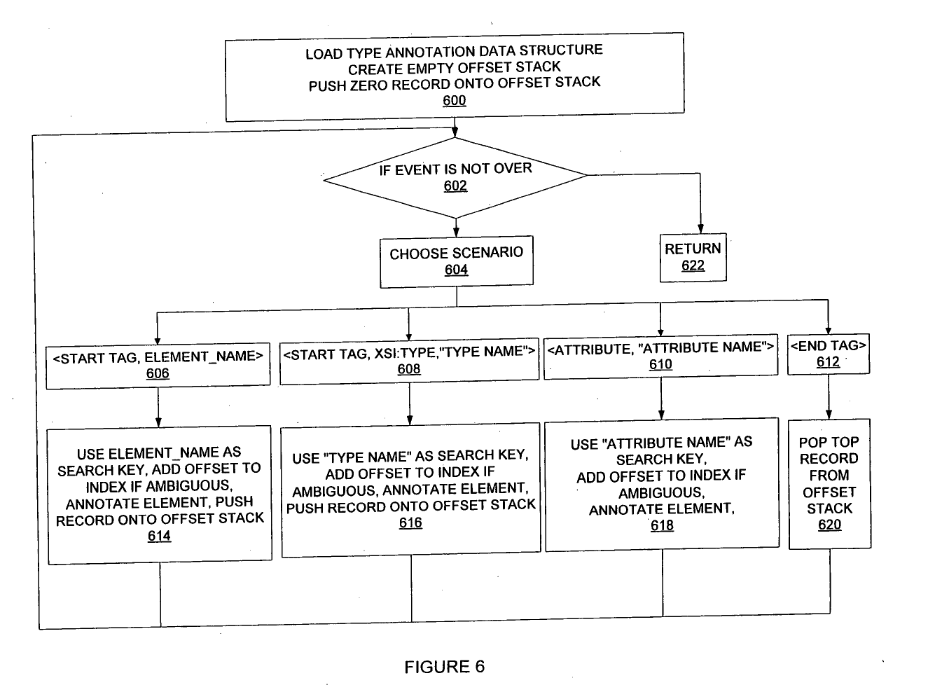

FIG. 7 is an exemplary XML schema.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

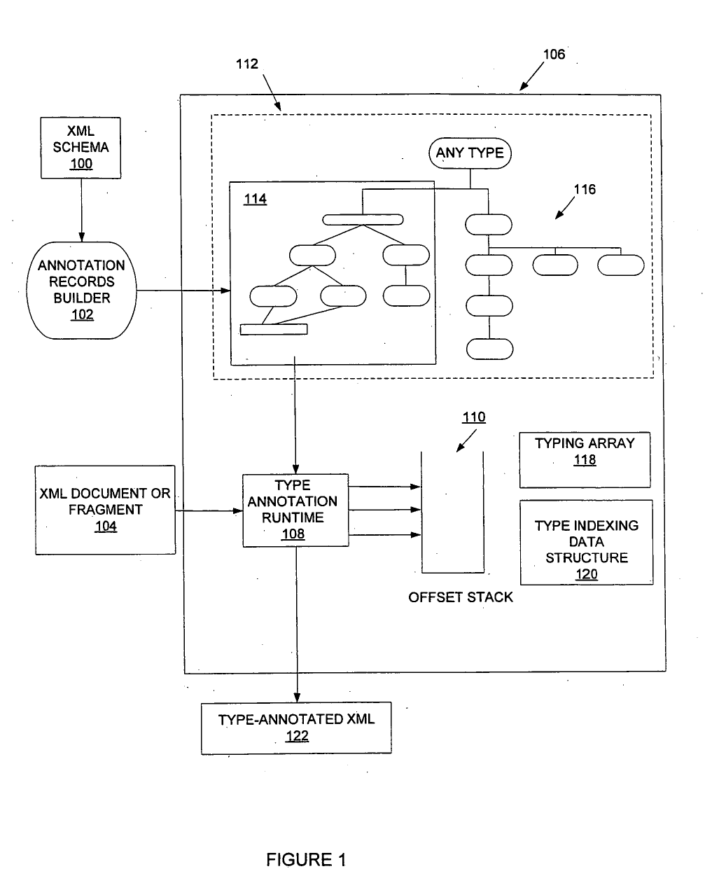

The system of the present invention shown in FIG. 1 comprises XML schema 100, which is provided as input, type annotation record builder 102, which is part of an XML Schema compiler (e.g., compiler shown in 60/418,673), XML document or document fragment 104, which is provided as input in event or tree model, and type annotation data structure 106. Type annotation data structure 106 further comprises type annotation runtime 108, offset stack 110, and type hierarchy tree 112. Type hierarchy tree 112, is also comprised user-defined types 114 and built-in types 116. Type annotation runtime 108 is further comprised of typing array 118 and type indexing data structure 120. Type-annotated XML document or document fragment 122 is provided as an output of the system of the present invention.

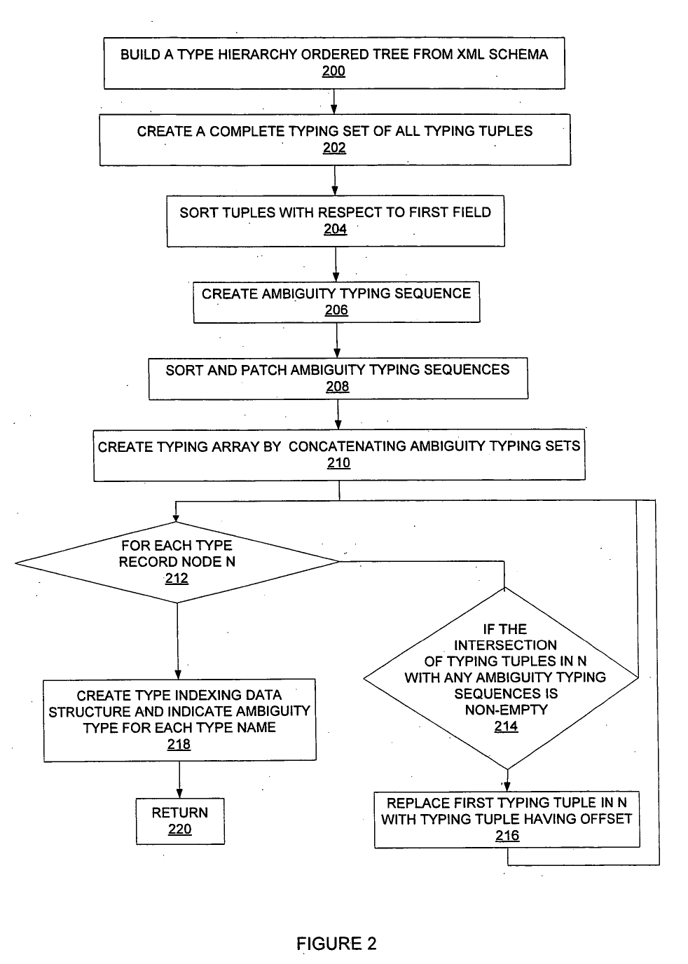

Shown in FIG. 2 is a first algorithm of the present invention, known as Compile_XML_Schema algorithm, which describes the compilation of an XML schema. In an initial step 200, a type hierarchy is built from an XML schema, based on a derivation of relationships among types. For each complex type in a schema, a type record is created. Each type record in a type hierarchy contains typing tuples for sub-elements and attributes of a specified type. Assuming no overlap, both element and attribute names are listed together, in a type record. If there is an overlap between an element and attribute name, a specified string is prefixed to an attribute name. Each typing tuple is comprised of a type name, element name, or string-valued attribute name as a first field, a type identifier as a second field, and a parent element name as a third field. If an element is of global element type, the corresponding third field will remain empty. For each type record, all tuples are determined in this manner. After all tuples are determined, a typing set is formed by the union of all typing tuples corresponding to type records formed in step 202. The number of typing tuples in a type record is dependant on the number of sub-elements and attributes for a given element type. In step 204, a typing set is sorted with respect to a first string field, in alphabetical order. In step 206, an ambiguity typing sequence is created for those tuples sharing a common first field and having a unique second field. Third fields from typing tuples in an ambiguity typing sequence are then collected and sorted. Since it is necessary for global types to be unique, a collection of third fields from an ambiguity typing sequence should not contain any empty members. After third fields are sorted, an offset number is assigned to each typing tuple in accordance with its position in sorted order. In step 208, typing tuples within each ambiguity typing sequence are then arranged based on the unique offset numbers assigned to each third field. Each offset number assigned to each third field is unique within an ambiguity typing sequence since there is no ambiguity within each parent element.

Following the step of sorting and arranging 208, a type array is created by extracting types found in the second field of a typing tuple according to the sorted order of ambiguity typing sequences in step 210. Types not included in ambiguity sequences, which are also extracted from the second field of typing tuples, are listed following those typing tuples that are members of an ambiguity typing sequence. It is of note that multiple entries for a given type may exist if the type is included in multiple ambiguity sequences. Entries in a type array that correspond to type names with an offset number assigned as described previously, are also given the same offset number. Those entries that have no offset number are assigned an offset number of zero. As a last step 218 in the algorithm of the present invention, an index structure is created to link each type name extracted from a first field of a typing tuple to its corresponding type. Index entries will have a string field denoting element type, a flag field denoting ambiguity, and an index field denoting the index of an element type in a type array. A flag field is given a value of ‘Y’ if a corresponding element type is ambiguous and ‘N’ if it is not ambiguous. An index field is given a value corresponding to the index of an element type in a type array if a corresponding flag field is set to ‘N’ and the first index entry in a type array for an ambiguity sequence if a corresponding flag field is set to ‘Y’. An index structure is implemented by, but is not limited to, one of the following data structures: hash tables, binary trees, and B+ trees.

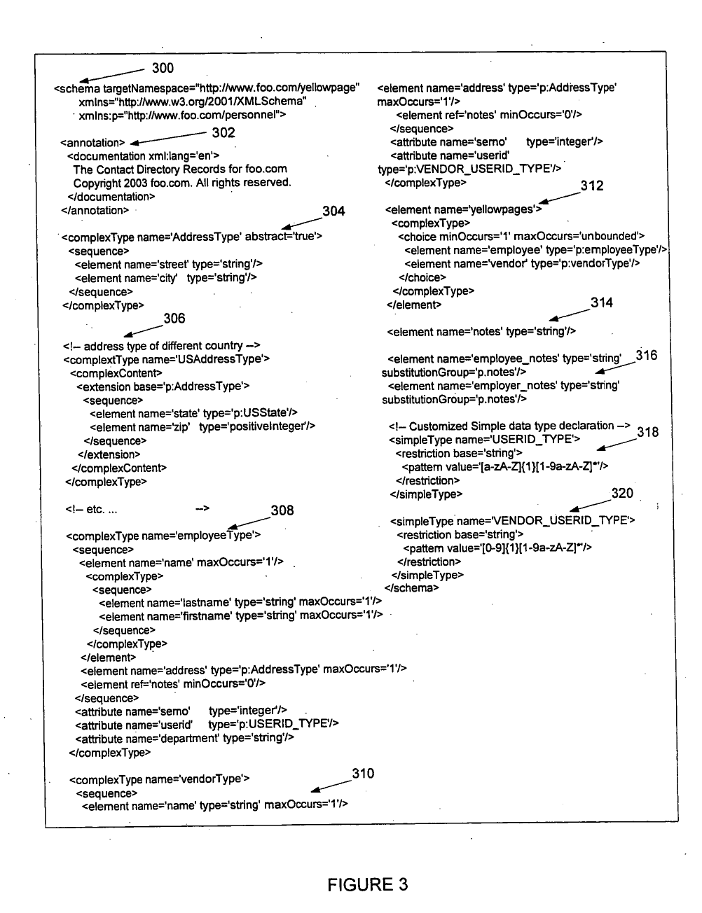

The exemplary XML schema in FIG. 3 comprises such features as an abstract element type 304, complex type 306, anonymous element type 312, and substitution group 316. FIG. 3 is used to illustrate the execution of a first XML compilation algorithm of the present invention.

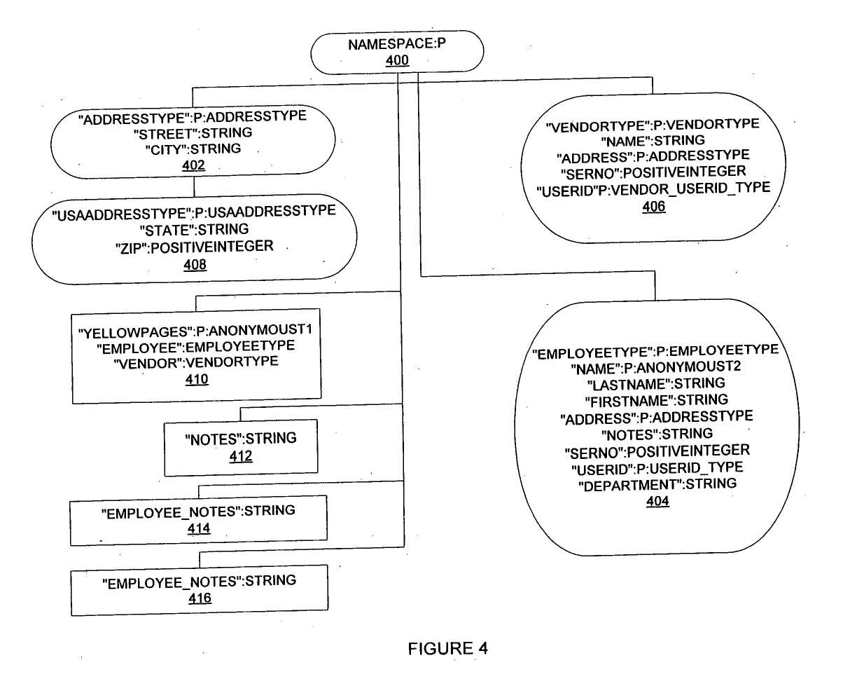

FIG. 4 illustrates a type hierarchy tree built by an initial step of a first algorithm of the present invention for the XML schema shown in FIG. 3. Except for “namespace:p” root node 400, all nodes are type records. Determined from a type hierarchy tree is the following typing set.

{ <“AddressType”, AddressType, “”>, <“street”, string, “AddressType”>, <“city”,
string,“AddressType”>, <“USAdressType”, USAddressType, “”>, <“state”, string,
“USAddressType”>,<“zip”, positiveInteger, “USAddressType”>,
<“employeeType”, p:employeeType, “”>, <“name”, p:anonymousT2,
“employeeType”>, <“lastname”, string, “name”>, <“firstname”, string, “name”>,
<“address”, AddressType, “employeeType”>,
<“notes”, string, “employeeType”>, <“serno”, positiveInteger, “employeeType”>,
<“userid”, p:USERID_TYPE, “employeeType”>, <“department”, string,
“employeeType”>, <“yellowpages”, p:anonymousT1, “”>,
<“employee”, employeeType, “yellowpages”>, <“vendor”, p:vendorType,
“yellowpages”>, <“employee_notes”, string, “”>, <“employer_notes”, string, “”>,
<“vendorType”, p:vendorType, “”>, <“name”, string, “vendorType”>, <”address”,
AddressType, “vendorType”>, <”serno”, positiveInteger, “vendorType”>,
<“userid”, p:VENDOR_USER_ID_TYPE, “vendorType”>}

In the exemplary ambiguity typing set, the first field in each tuple is a type name, the second field is a type identifier, and the third field is the parent element name of a type name designated in the first field.

The exemplary XML schema shown in FIG. 3 produces the following ambiguity sequence.

{<“name”, string, “vendorType”>, <“name”, p:anonymousT2,
“employeeType”>},
{<“userid”, p:USERID_TYPE, “employeeType”>, <“userid”,
p:VENDOR_USER_ID_TYPE, “vendorType”>}

Tuples comprising an ambiguity sequence are characterized by the fact that each has a type name associated with more than one type, and thus do not provide a distinct mapping between element type name and element type.

In the exemplary ambiguity sequences, two element types, “employeeType” and “vendorType” are included and are assigned offset numbers of zero and one, respectively. Arranging typing tuples according to assigned offset numbers produces the following sequences.

{<“name”, p:anonymousT2, “employeeType”>, <“name”, string,
“vendorType”>},
{<“userid”, p:USERID_TYPE, “employeeType”>, <“userid”,
p:VENDOR_USER_ID_TYPE, “vendorType”>}

The typing tuple <“name”, p:anonymousT2, “employeeType”>, appears in the first position of the first sequence. The typing tuple <“userid”, p:USERID_TYPE, “employeeType”>, which is also an element of “employeeType”, appears in the first position of the second sequence.

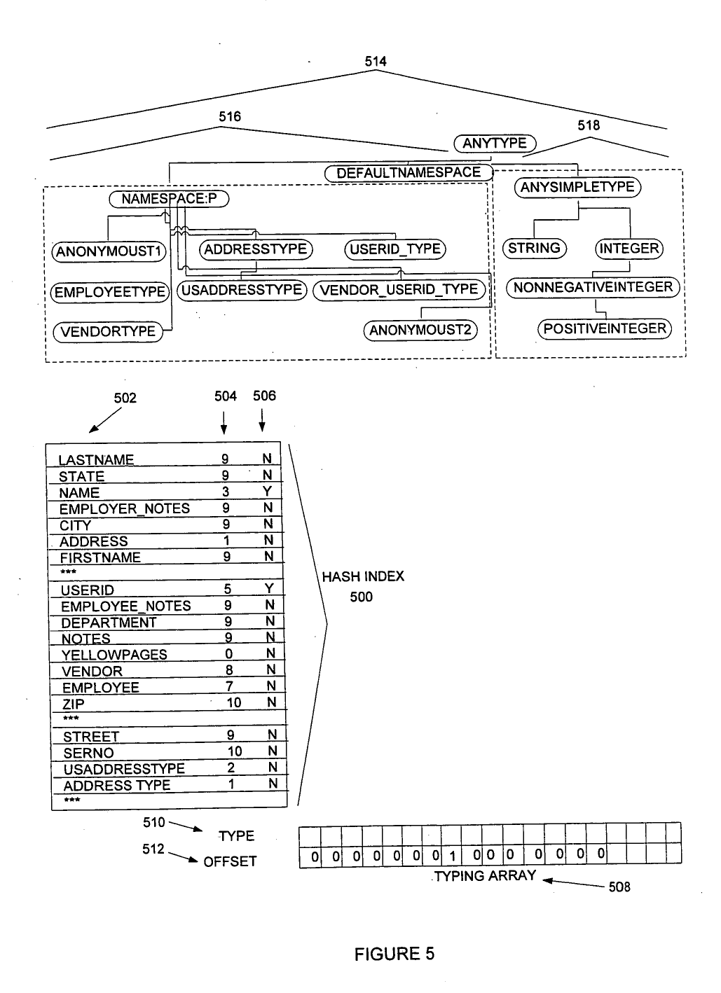

The final output of the algorithm creating an index structure is shown in FIG. 5. In the exemplary figure a hashing index is chosen to implement typing index 500, however, the present invention not limited by this choice. Shown in FIG. 5 is typing indexing data structure 500 mapping type names 502 to indices 504 within typing array 508 as well as to an indication of whether a given type name is ambiguous or not 506. Also shown in FIG. 5 is typing array 508 in which an index is mapped to type 510 and offset 512. Type 510 in typing array 508 maps to types constructed from XML schema denoted by namespace1 in type hierarchy 514. In type hierarchy 514 both user-defined types 516 and built-in types 518 are shown.

A second algorithm of the present invention, known as annotate_type, provides for type annotation runtime for validated XML documents or fragments. The data structure shown in FIG. 5 is used to annotate XML data; either as a whole document or a fragment.

In an initial step 600 of the annotate_type algorithm, type annotation records from precompiled data structures shown in FIG. 5 are loaded into memory. An empty offset stack is then created, and a value of zero is pushed onto an empty offset stack. While there is an XML document or document fragment remaining to be annotated 602, it is determined whether tuples comprising the following combinations are encountered; <start tag, element_name> 606, <start tag, “element name”, xsi:type=“type name”> 608, <attribute, “attribute name”> 610, and <end tag> 612. If a tuple comprising a start tag and an element name (e.g., <start tag, element_name>) is encountered as in step 606; then in step 614 type indexing data structure 500 is searched with respect to element name 502 to determine an index 504. Also occurring in step 614, if index 504 determined has a positive indication 506 (e.g., ‘Y’ as shown in FIG. 5), then an index 504 is incremented by a PEEK value of the offset stack. A PEEK value of an offset stack is used to determine the value of the entry on the top of an offset stack. An index 504 is incremented in order to add the index from an index structure with the offset determined by a PEEK value. The resultant index of a given element type in a typing array is used to annotate an element. Also in step 614, the element is then annotated with type 510 stored in typing array 508 at index location 504 determined by previous searching step. Lastly in step 614, a record containing the offset 512 stored in a typing array 508 at an index location 504 determined by a previous searching step is pushed onto an offset stack. The same process is followed in step 616 if a tuple comprising a start tag, element name, type, and type name (e.g., <start tag, “element name”, xsi:type=“type name”>) is encountered in step 608; except a type indexing data structure 500 is searched with respect to type name 502 rather than an element name to determine an index 504. The same process is also followed in step 618 if an attribute and attribute name tuple are encountered 610 (e.g., <attribute, “attribute name”>); however, a type indexing data structure 500 is searched with respect to attribute name 502 to determine an index 504. In addition, a record is not pushed onto the offset stack. Lastly, if an end tag is encountered as in step 612, the top record in the offset stack is popped off in step 620. The process terminates in step 622.

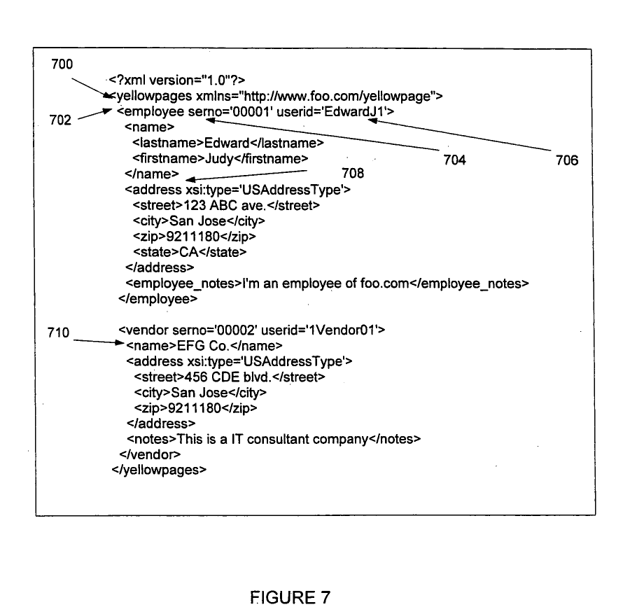

FIG. 7 shows an exemplary XML schema for the purposes of illustrating the principles of a second algorithm of the present invention. When <start tag, “yellowpages”> event 700 is encountered, since “yellowpages” is of a unique type, keying a search on type indexing data structure 500 using an “yellowpages” as a search key 502 will determine a type index 504. A type index entry 510 found in typing array 508 is zero, and the entry points to type anonymousT1 514.

When an <start tag, “employee”> 702 event is encountered, “employee” is used to key a search of type indexing data structure 500 to determine a typing index 502. In this case, the typing index 502 has a value of seven. The seventh entry of typing array 508 points to employeeType. Thus, a record containing an offset value 512 of zero of the seventh entry in typing array 508 is pushed onto an offset stack. When an <attribute, “semo”> 704 event is encountered, “semo” is used to key a search of type indexing data structure 500 to determine a typing index 502. In this case, the typing index has a value of ten. Because “serno” is a unique type, its entry 510 in typing array 512 is ten, which maps to positiveInteger type 518.

When an <attribute, “userid”> event 706 is encountered, “userid” is used to key a search of type indexing data structure 500 to determine typing index 504. In this case, the index 504 found in type indexing data structure 500 is determined to be five. Since a “userid” attribute has ambiguity, entry 510 in typing array 500 is five in addition to the offset on the top of an offset stack. In this case, the offset on the top of an offset stack is zero, so entry number 510 remains as five and corresponds to type USERID_TYPE 516.

When an <start tag, “name”> 708 event is encountered, “name” is used to key a search of type indexing data structure 500 to determine typing index 504. In this case, index 504 found in type indexing data structure 500 is determined to be three. Since a “name” attribute has ambiguity, entry 510 in typing array 508 is three in addition to the offset on the top of the offset stack. In this case, the offset on the top of offset stack is zero, so the entry number is three and corresponds to type anonymousT2 516. Since the entry number has an offset of zero 512, a record containing zero is pushed onto offset stack.

When an <start tag, “name”> 710 event is encountered, “name” is used to key a search of type indexing data structure 500 to determine typing index 504. In this case, index 504 found in type indexing data structure 500 is determined to be three. Because “name” has ambiguity 506, entry 510 is three in addition to the offset on the top of offset stack, which is one. Thus, the actual cell location to which a type 514 is mapped is at index four and corresponds to type string 518. Since entry 510 has an offset value of one 512, a record containing a value of zero is pushed onto an offset stack.

The algorithm of the present invention is modifiable to support default values. Default values for elements are supplied when an element is empty and there exists a default declaration for the specified element type. Default value support is achieved by storing default information during compilation of an XML schema and determining if an element is empty or not. To support attribute default values, a list of attributes associated with a given element is stored and referenced during type annotation since attribute default values are supplied when an attribute is missing from an element. For this reason, attributes and their associated elements are no longer stored separately.

Support of the attribute xsi:nil=“true” is achieved by skipping type annotation of the associated element and sub-elements. Support of xs:anyType is achieved by annotating xs:anyType to an element name that is declared to have xs:anyType and omitting the step of annotating sub-elements. In another embodiment, if sub-elements of a given element are known to be of unique types, they are annotated to a proper type in a manner as described previously. In addition, sub-elements with unknown type names are annotated with xs:anyType.

Additionally, the present invention provides for an article of manufacture comprising computer readable program code contained within implementing one or more modules to build an XML type hierarchy, populate a type indexing data structure and typing array, map a type name string to an element type in an XML type hierarchy, and to annotate types in an XML document or fragment. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) building an XML type hierarchy; (b) populating a type indexing data structure; (c) populating a typing array; (d) creating a mapping between typing array entries and XML type hierarchy; and (d) annotating XML type.

### CONCLUSION

A system and method has been shown in the above embodiments for the effective implementation of an efficient type annontation of XML schema-validated XML documents without schema validation. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program or computing environment.

The above enhancements are implemented in various computing environments. For example, the present invention may be implemented on a conventional IBM PC or equivalent. All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of object-oriented programming.

1. A method for compiling a structured document schema into type annotation records comprising steps of:
a. building a type hierarchy ordered tree from a structured document schema from type record wherein each of said type records contains typing tuples,
b. creating a typing set containing said typing tuples in said type hierarchy ordered tree,
c. creating an ambiguity typing sequence for said typing tuples sharing a common first field and having a unique second field,
d. arranging said ambiguity typing sequence based on an offset number assigned to a third field of each of said typing tuples in said ambiguity typing sequence,
e. extracting a second field from each of said typing tuples accorded to sorted order of said ambiguity typing sequences, and
creating a type indexing data structure populated with said extracted second field to map each type name to a type.

2. A method for the compilation of a structured document schema, as per claim 1, wherein said structured document schema is an XML document schema

3. A method for the compilation of a structured document schema, as per claim 1, wherein said typing tuples in said typing set are sorted to create said ambiguity typing sequence.

4. A method for the compilation of a structured document schema, as per claim 1, wherein said arranging step is further comprised of: collecting each third field of said typing tuples and sorting said typing tuples in said ambiguity sequence with respect to third field of said typing tuple.

5. A method for the compilation of a structured document, as per claim 1, wherein a typing tuple is comprised of an element type name in said first field, a type identifier in said second field, and a parent element name in said third field.

6. A method for the compilation of a structured document, as per claim 5, wherein said name in said first field is used in said sorting step to alphabetically sort said typing tuples in typing set.

7. A method for the compilation of a structured document, as per claim 5, wherein said name is one of: a type name, element name, or attribute name; and said type identifier is one of: a type, element, or attribute.

8. A method for the compilation of a structured document, as per claim 5, wherein said third field is empty if said parent element name corresponds to a global element type.

9. A method for the compilation of a structured document, as per claim 5, wherein a typing set is comprised of distinct typing tuples, wherein two typing tuples are distinct if either said first fields of both of said typing tuples are different or said second fields of both of said typing tuples are different.

10. A method for the compilation of a structured document, as per claim 1, wherein said offset in said arranging is the position of said ambiguity type in an ambiguity typing sequence.

11. A method for the compilation of a structured document, as per claim 1, wherein said type indexing data structure can be any one of: a hash table, a binary tree, and a B+ tree.

12. A method for the compilation of a structured document, as per claim 1, wherein said type indexing data structure is comprised of a column indicating ambiguity type for each of said type names and a column indicating offset.

13. A method for a database engine to perform type annotation of structured documents or structured document fragments in the absence of full schema validation, comprising steps of:
a. building a type annotation data structure comprising a structured document type hierarchy, a type indexing data structure, and a type array,
b. mapping a type name string to each element type in said structured document type hierarchy, and
annotating a structured document or fragment using type annotation records obtained from said type annotation data structure and said type name mapping.

14. A method for a database engine to perform type annotation, as per claim 13, wherein said mapping step further comprises steps of:
a. loading said type annotation data structure into a runtime validation engine,
b. creating an empty offset stack data structure,
c. pushing record containing a value of zero onto said offset stack,
d. using a token from an XML document or document fragment to key a search on a type indexing data structure to determine an index for said token,
e. incrementing said index by value in topmost record of offset stack if said token is indicated to be of ambiguous type, and
indicating element type in a type array at said index location.

15. A method for annotating type, as per claim 14, wherein said type is an XML type.

16. A method for annotating type, as per claim 14, wherein said record is a type annotation record.

17. A method for annotating type, as per claim 14, wherein said method supports defaults, “any” type, and “xsi:nil=‘true’” attribute.

18. A method for annotating type, as per claim 17, wherein attribute defaults are supported by associating attribute types with element types in said type annotation records.

19. A method for annotating type, as per claim 17, wherein a type is annotated with “any” type if an index is not located for said token in said searching step.

20. A method for annotating type, as per claim 17, wherein said method is not performed if an “xsi:nil=‘true’ attribute is encountered.

21. A method for annotating type, as per claim 14, wherein said token comprises any of: a start tag and element name; a start tag, element name, and type name; an attribute type and attribute name; or an end tag.

22. A method for annotating type, as per claim 14, wherein said ambiguous type of said token is determined by a consultation of said typing array.

23. A method for annotating type, as per claim 14, wherein a record is pushed onto said offset stack if said token is either a start tag and element name; or a start tag, element name, and type name.

24. A method for annotating type, as per claim 14, wherein if said token is an end tag; a topmost record of said offset stack is removed.

25. An article of manufacture comprising a computer usable medium having computer readable program code embodied therein which implements the compilation of a structured document schema into type annotation records comprising modules to execute the steps of:
a. building a type hierarchy ordered tree from a structured document schema from type record wherein each of said type records contains typing tuples,
b. creating a typing set containing said typing tuples in said type hierarchy ordered tree,
c. creating an ambiguity typing sequence for said typing tuples sharing a common first field and having a unique second field,
d. arranging said ambiguity typing sequence based on an offset number assigned to a third field of each of said typing tuples in said ambiguity typing sequence,
e. extracting a second field from each of said typing tuples accorded to sorted order of said ambiguity typing sequences, and
creating a type indexing data structure populated with said extracted second field to map each type name to a type.

26. An article of manufacture comprising a computer usable medium having computer readable program code embodied therein which comprising modules to execute the steps of:
a. loading type annotation data structure into a runtime validation engine,
b. creating an empty offset stack data structure,
c. pushing a record containing a value of zero onto said offset stack,
d. using a token from an XML document or document fragment to key a search on a typing index to determine an index for said token,
e. incrementing said index by value in topmost record of offset stack if said token is indicated to be of ambiguous type, and
indicating element type in a typing array at said index location.
